(19) United States
(12) Patent Application Publication
(10) Pub. No.: US 2025/0137910 A1
(43) Pub. Date: May 1, 2025

(54) PARTICLE SORTING DEVICE, ORIFICE UNIT FOR PARTICLE SORTING DEVICE, AND PARTICLE SORTING METHOD

(71) Applicant: Sony Group Corporation, Tokyo (JP)

(72) Inventors: Shin Masuhara, Tokyo (JP); Tomoyuki Umetsu, Tokyo (JP); Tsutomu Maruyama, Kanagawa (JP); Masahide Furukawa, Tokyo (JP)

(73) Assignee: Sony Group Corporation, Tokyo (JP)

(21) Appl. No.: 18/692,176

(22) PCT Filed: Feb. 8, 2022
(86) PCT No.: PCT/JP2022/004862

§ 371 Date: Mar. 14, 2024

(30) Foreign Application Priority Data
Sep. 21, 2021 (JP) 2021-153571

(51) Int. Cl. G01N 15/1492; G01N 15/1409

(52) U.S. Cl. CPC G01N 15/1492; G01N 15/1409; G01N 2015/1411

(57) ABSTRACT

To provide a technology capable of stabilizing droplet trajectory.

Provided is a particle sorting device or the like including: an irradiation unit that irradiates a part of a flow path through which a fluid containing particles flows with laser light; a detection unit that detects light generated by irradiation of the laser light; an orifice that is disposed at an end of the flow path and discharges the fluid; a conductive portion disposed in a vicinity of a position where the fluid is formed into a droplet; and a charging unit that applies a charge to the conductive portion on the basis of light data detected by the detection unit.

### TECHNICAL FIELD

The present technology relates to a particle sorting device, an orifice unit for the particle sorting device, and a particle sorting method. More specifically, the present technology relates to a particle sorting device, an orifice unit for a particle sorting device, and a particle sorting method capable of stabilizing a droplet trajectory.

### BACKGROUND ART

Currently, a technology called flow cytometry is used for analyzing biologically relevant particles such as cells and microorganisms, and particles such as microbeads. Flow cytometry is an analysis method in which particles are poured in a state of being aligned in a fluid, and the particles are irradiated with light and light emitted from each particle is detected, thereby analyzing and sorting the particles. A device used for the flow cytometry is called a flow cytometer (also referred to as a “cell sorter”).

In a flow cytometer, generally, a vibrating element is provided at a section of a flow path through which particles encased in sheath liquid flow, and this vibrating element vibrates a portion of the flow path to continuously form the fluid discharged from an orifice of the flow path into droplets. Then, on the basis of a detection signal obtained by the light irradiation, the droplets containing particles are charged positively (+) or negatively (−), or left uncharged, and split by a deflector plate according to the charge state, and the target particles are collected in the respective recovery vessels. The group of droplets deflected to the left or right by the positive charge or the negative charge passes through a certain trajectory, and becomes a linear, inclined liquid flow in appearance. A group of uncharged droplets traveling vertically downward is called a “center stream”, whereas the inclined linear liquid flows are called “side streams”.

It is important to efficiently and accurately charge the droplets using an appropriate method so that this side stream is correctly guided to the recovery vessel. In response to this, for example, Patent Document 1 discloses a technology for stabilizing droplets by controlling the driving voltage of the vibrating element so that the distance between the end of a droplet immediately before break-off and the end of a satellite droplet one position before the droplet is constant in a droplet observation image.

### CITATION LIST

### Patent Document

Patent Document 1: WO 2014/115409 A

### SUMMARY OF THE INVENTION

### Problems to be Solved by the Invention

However, the reality is that the technology for maintaining a constant side-stream trajectory is still insufficient and further development of the technology is required.

Therefore, an object of the present technology is mainly to provide a technology capable of stabilizing a droplet trajectory.

### Solutions to Problems

The present technology first provides a particle sorting device including: an irradiation unit that irradiates a part of a flow path through which a fluid containing particles flows with laser light; a detection unit that detects light generated by irradiation of the laser light; an orifice that is disposed at an end of the flow path and discharges the fluid; a conductive portion disposed in a vicinity of a position where the fluid is formed into a droplet; and a charging unit that applies a charge to the conductive portion on the basis of light data detected by the detection unit.

Furthermore, the present technology also provides an orifice unit for a particle sorting device, including an orifice that is partially or entirely conductive and a conductive portion that supports the orifice.

Moreover, the present technology also provides a particle sorting method including: an irradiation step of irradiating a part of a flow path through which a fluid containing particles flows with laser light; a detection step of detecting light generated by irradiation of the laser light; and a charging step of applying a charge to a conductive portion disposed in a vicinity of a position where the fluid is formed into a droplet on the basis of light data detected by the detection unit.

### BRIEF DESCRIPTION OF DRAWINGS

FIG. 1 is a diagram illustrating a relationship between a droplet cycle and a correct timing of a charge signal.

FIG. 2 is a diagram illustrating a state in which a droplet changes near a break-off position and a side-stream trajectory opens and closes accordingly in a case where the droplet having a droplet frequency of 100 kHz is left for 2000 seconds.

FIG. 3 is a diagram schematically illustrating a configuration example of a flow cell system.

FIG. 4 is a diagram schematically illustrating a configuration example of a chip system.

FIG. 5 is a diagram schematically illustrating a configuration example of a charging method B.

FIG. 6 is a diagram schematically illustrating a configuration example of a charging method A and a charging method C.

FIG. 7 is a diagram illustrating a comparison result between an original signal waveform and an effective waveform at an orifice position when a pulse of a voltage ±175 V is applied to a metal sample liquid nozzle in a state where a flow cell flow path is filled with sheath liquid.

FIG. 8 is a diagram schematically illustrating a configuration example of a first embodiment of a particle sorting device 1 according to the present technology.

FIG. 9 is a diagram schematically illustrating another configuration example of the first embodiment of the particle sorting device 1 according to the present technology.

FIG. 10 is a diagram schematically illustrating a configuration example of a ground electrode.

FIG. 11 is a diagram illustrating a configuration example of an optical system around a droplet formation unit in a case of the flow cell system.

A to C of FIG. 12 are diagrams schematically illustrating mode examples of an orifice O and a conductive portion R.

D to F of FIG. 13 are diagrams schematically illustrating mode examples of the orifice O and the conductive portion R.

G to I of FIG. 14 are diagrams schematically illustrating mode examples of the orifice O and the conductive portion R.

FIG. 15 is a diagram schematically illustrating a configuration example of an orifice O according to the first embodiment of an orifice unit U.

FIG. 16 is a diagram schematically illustrating a configuration example of the first embodiment of the orifice unit U.

FIG. 17 is a diagram schematically illustrating a configuration example of a second embodiment of an orifice unit U.

FIG. 18 is a diagram schematically illustrating a configuration example of a third embodiment of an orifice unit U.

FIG. 19 is a diagram schematically illustrating a configuration example of a fourth embodiment of an orifice unit U.

FIG. 20 is a diagram schematically illustrating a configuration example of an embodiment in a case of the chip system.

FIG. 21 is a diagram illustrating a comparison result of charge signal waveforms of Example and Comparative Example.

FIG. 22 is a diagram illustrating a comparison result of a relationship between a side stream deflection distance and a charge signal phase in Example and Comparative Example.

FIG. 23 is a diagram illustrating a comparison result of charge waveforms related to correction of a charge signal.

### MODE FOR CARRYING OUT THE INVENTION

Hereinafter, preferred embodiments for carrying out the present technology will be described with reference to the drawings.

The embodiments to be described below are intended to illustrate examples of representative embodiments of the present technology, and the scope of the present technology will not be construed narrower by these embodiments. Note that description will be given in the following order.
1. Outline of Present Technology
2. First Embodiment (particle sorting device 1)
   (1) Flow Path P
   (2) Irradiation Unit 11
   (3) Detection Unit 12
   (4) Orifice O
   (5) Conductive Portion R
   (6) Charging Unit 13a
   (7) Deflector Plate 13b, Recovery Vessel 13c
   (8) Vibration Unit 14
   (9) Imaging Unit 15
   (10) Break-off Control Unit 16
   (11) Analysis Unit 17
   (12) Storage Unit 18
   (13) Display Unit 19
   (14) User Interface 20
   (15) Others
3. Mode Example of Orifice O and Conductive Portion R
   (1) Mode Example of Flow Cell System
   (2) Mode Example of Chip System
   (3) Orifice Unit U for Particle Sorting Device
   (3-1) First Embodiment of Orifice Unit U
   (3-2) Second Embodiment of Orifice Unit U
   (3-3) Third Embodiment of Orifice Unit U
   (3-4) Fourth Embodiment of Orifice Unit U
   (4) Embodiment in Case of Chip System
4. Second Embodiment (Particle Sorting Method)

### 1. Outline of Present Technology

The present technology is to efficiently and accurately charge droplets using an appropriate method in order to maintain a constant side-stream trajectory that carries particles to a recovery vessel in a device that irradiates particles in a state of being aligned in a flow path with light, detects light emitted from each of the particles, charges the droplets containing the particles positively (+) or negatively (−) by a counter electrode, or leaves the droplets uncharged, on the basis of a detection signal, splits the droplet into respective droplet trajectories by a deflector plate, and collects the target particle.

Charging of the droplet containing the target particle is performed by bringing an electrode into contact with conductive sheath liquid in a droplet formation unit and applying a pulse signal of positive polarity or negative polarity to the electrode according to a deflection direction. A charge signal is transmitted to a tip of a liquid column through the sheath liquid, and an amount of charge proportional to a voltage immediately before the droplet is detached is charged. In this case, a width of the charging pulse is generally equal to one droplet cycle T (for example, in the case of a droplet having a droplet frequency of 100 kHz, T is about 10 μsec), and the voltage is about ±100 to 200 V.

Here, in order to stabilize the trajectory of the side stream including the droplets containing the target particles, accurate charging is required so that a uniform charge amount is given to each droplet.

As described above, since the droplet is charged at the moment when the droplet is detached from the liquid column, it is essential to adjust the timing of the droplet detachment (Hereinafter, it is referred to as “break-off”.) and the charging pulse and apply the maximum voltage. When the adjustment of the timing is not appropriate, a sufficient charge cannot be applied to the droplet, a deflection angle decreases in proportion to the charge amount, and the side stream is closed inward.

The charging pulse usually has a time width (T) equal to one droplet cycle, and hence the timing is first adjusted so that the break-off time of the droplet including the target particle falls within a charging pulse width (T). However, with the actual charging pulse causing a rise time (Tr) and a fall time (Tf) of the signal, an effective pulse width (Te) at the maximum voltage (Vtop) is decreased by subtracting them from T: “Te=T−(Tf+Tr)”. For example, when a droplet frequency of is 100 kHz, a cycle T is 10 μsec, and when both Tr and Tf are 3 μsec, Te is a value reduced by a half, which is 4 μsec. Therefore, in a simplified manner, this Te value is considered to be a margin allowed as the temporal variation in the break-off.

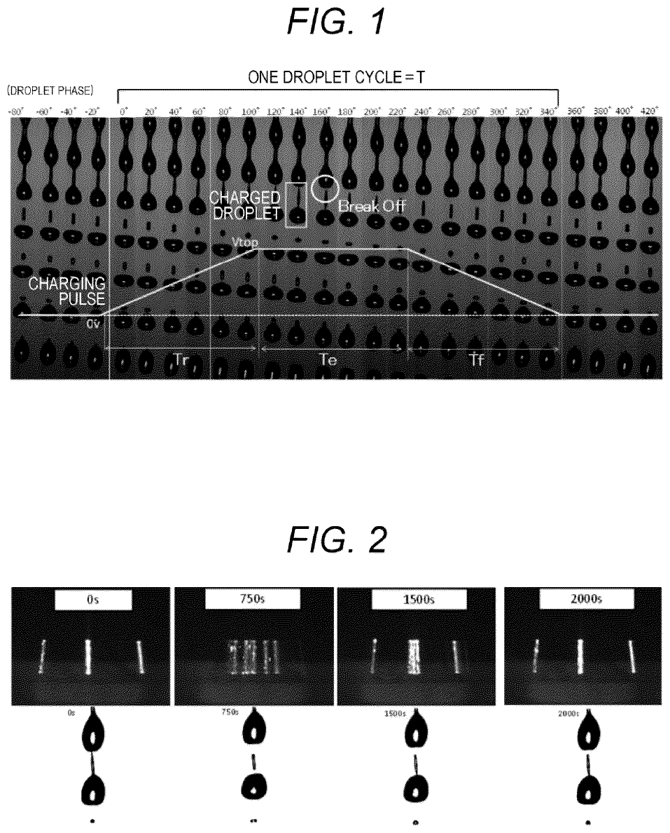

FIG. 1 illustrates a relationship between a droplet cycle and a correct timing of a charge signal.

The variation of the break-off timing of the droplet can be observed in detail, for example, by illuminating the droplet with a light source that blinks in synchronization with a piezoelectric drive signal and obtaining a strobe image from a droplet observation camera.

FIG. 2 illustrates a state in which a droplet changes near a break-off position and a side-stream trajectory opens and closes accordingly in a case where the droplet having a droplet frequency of 100 kHz is left for 2000 seconds.

In the example illustrated in FIG. 2, the phase of the charging pulse is adjusted to the droplet so that the side stream opens at the maximum angle at the start of observation. Therefore, the break-off timing is advanced with the time, and in particular, a change in the length and position of a satellite droplet located between the main droplets can be seen. Then, after 2000 seconds, the side stream returns to the maximum angle due to an advancement in the break-off timing by an amount substantially corresponding to one droplet cycle (that is, T). However, the lower droplet, originally required to be charged, is not deflected, but the upper droplet shifted by one position is deflected.

From the above, since the variation in the break-off timing of the droplets directly causes the side-stream trajectory to be disturbed, strict management is required.

On the other hand, for example, in Patent Literature 1 described above, a droplet is stroboscopically captured with illumination light synchronized with a frequency, and feedback control is performed to a piezoelectric drive voltage on the basis of strobe image information so that a change does not occur in the vicinity of BOP. However, even in a case where the feedback control is performed, the variation in the break-off timing of the droplets cannot be constantly maintained at 0, and the variation of about ±0.1 to 0.2T may remain. Thus, it is considered that it is important to widen the effective pulse width (Te), with which the maximum voltage (Vtop) of the charging pulse is obtained, to the maximum extent, in order to secure the stability of the side-stream trajectory.

Here, as one of methods of securing the wide effective pulse width (Te) by reducing the rise time (Tr) and the fall time (Tf) in the charging pulse of the time width (T), there is a method of optimizing an electrode position for supplying a charge signal.

The electrode that gives the charge signal to the sheath liquid is desirably installed at a distance as close as possible to the BOP. This is because it takes a certain time for electrons and ions to move from the electrode to the break-off position at the tip of the liquid column after voltage application. When the voltage (V) applied to the droplet after the application of the charge signal of the voltage (V₀) is expressed as a function of an elapsed time after the application (t), “V=V₀×(1−exp(−t/τ))” is obtained. Here, a time constant (τ) is proportional to “r×C”, which is the product of a resistance value (r) between the electrode and the BOP and a capacitance (C) between the sheath liquid column and the ground electrode. As the time constant T decreases, the rise/fall time decreases, and the effective pulse width (Te) can be increased. Thus, it is desirable to lower the resistance value (r) between the electrode and the BOP. This resistance value (r) is caused on the basis of the sheath liquid (electrical resistivity of approximately 0.2 Ωm) present between the electrode and the BOP, that is, a shorter distance between the electrode and the BOP is the solution.

Here, an installation location of a charge signal electrode in a conventional cell sorter will be described.

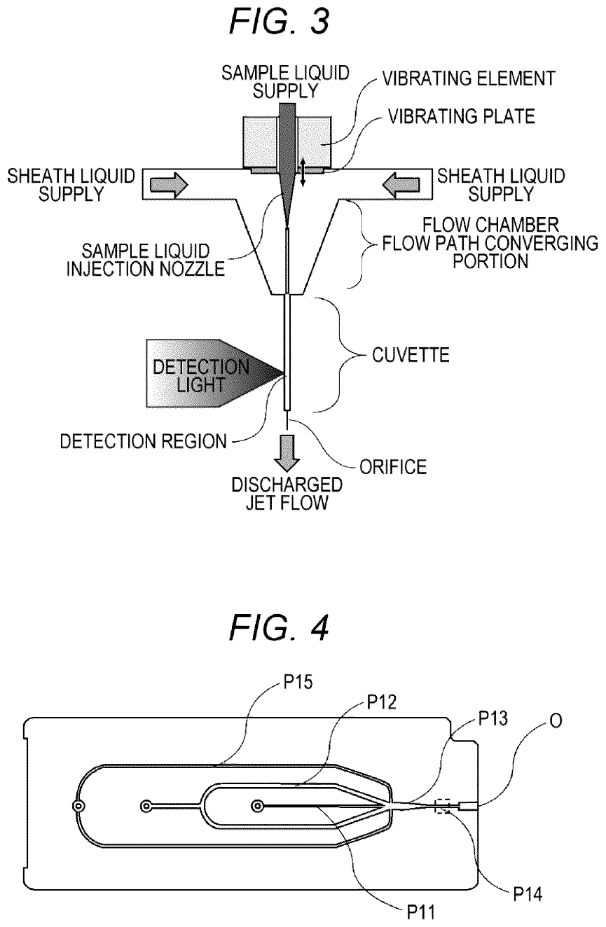

A typical type of a droplet formation unit including an electrode includes a flow path portion that merges sheath liquid and a sample flow to form a laminar flow, a piezoelectric vibration unit that applies vibration to the liquid at a desired frequency, a detection unit that irradiates a particle with laser light in the linear flow path, and an orifice that discharges the light from the particle and a liquid column. Furthermore, there is also a type called a “jet-in-air system” in which irradiation of the particle with the laser light is performed in the liquid column portion after the sheath liquid containing the particle is discharged from the orifice. Among them, commercially available products are roughly classified into the following two forms, but those forms have the similar basic configurations described above.
A flow cell system in which a flow path system is fixed and only a nozzle at the tip is replaceable (see FIG. 3)
A chip system in which an entire flow path system including an orifice is integrated and replaceable (see FIG. 4)

A charge signal is applied to the sheath liquid via the electrode in a droplet formation unit, but on the other hand, a ground electrode, which is another electrode connected to the ground (GND), is required within 1 mm near the BOP. Although the ground electrode and the sheath liquid are not in contact with each other, the ground electrode and the sheath liquid are grounded at the endpoint of the liquid column, and charging proportional to the potential difference from the signal is performed. Here, since electrical insulation between both electrodes is important, a main portion of the droplet formation unit needs to include an insulating material, and there is basically no place where the sheath liquid comes into contact with a conductive material inside the droplet formation unit in both the flow cell system illustrated in FIG. 3 and the chip system illustrated in FIG. 4.

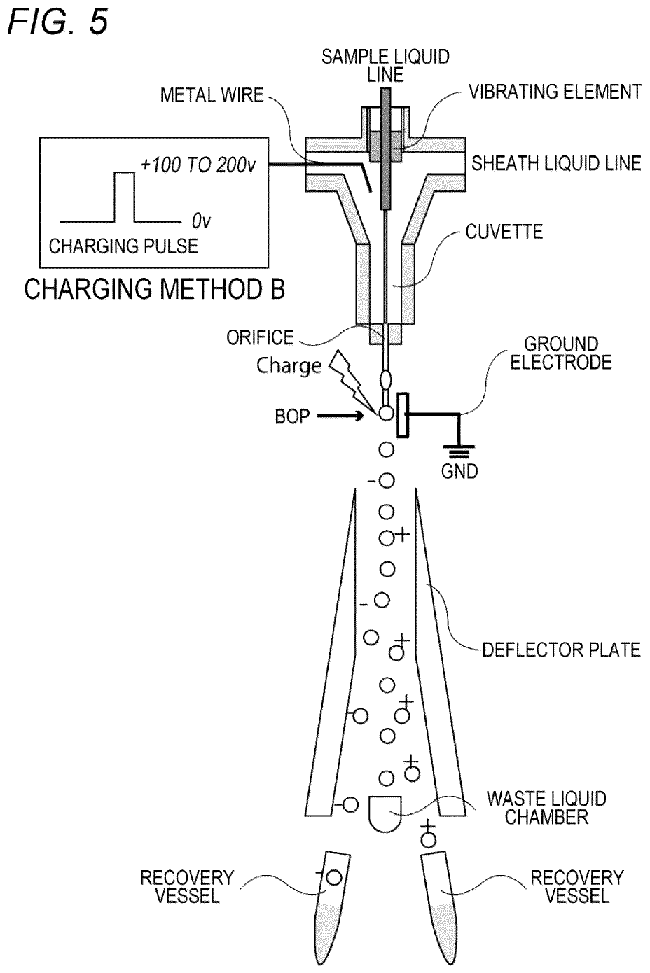

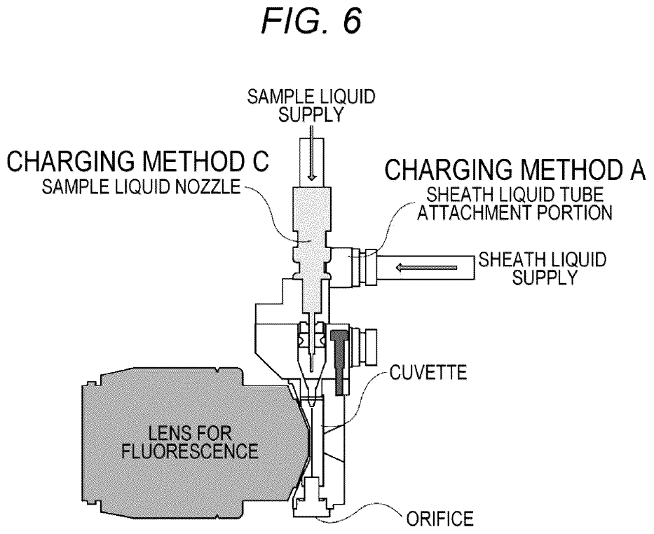

Therefore, conventionally, the sheath liquid has been charged in a form in which the charge signal is wired to a metal contact of a sheath liquid tube attachment portion (charging method A; see FIG. 6), or a form in which a metal wire is inserted into the flow path (charging method B; see FIG. 5). Alternatively, Japanese Patent Application Laid-Open No. 2010-54492 also discloses a technique in which a sample liquid nozzle for merging a sample liquid containing particles with sheath liquid is formed with a metal microtube, and a charge signal is applied to the metal microtube (charging method C; see FIG. 6).

However, in these methods, the sheath liquid is charged before the sheath liquid merges with the sample liquid to form a laminar flow, and it is difficult to bring the charge position closer to the BOP side than the sheath liquid merges with the sample liquid. For example, if the above-described metal wire is extended to a point where the laminar flow is already formed, vibration or the like of the metal wire may cause the laminar flow to be disturbed. In addition, a diameter of the flow path is reduced while narrowing a cross section from an inlet toward the orifice having an opening diameter of about 0.1 mm, and the diameter is reduced to 0.3 mm or less in or after the linear flow path in a cuvette, so that it becomes more difficult to physically install the metal wire as the flow path approaches the orifice.

As described above, in the actual cell sorter, the position of the electrode that charges the sheath liquid is limited to the first half of the droplet formation unit, that is, the position before the sheath liquid and the sample liquid merge to form a laminar flow. However, since the distance from the charge position to the BOP is about 40 to 50 mm, it takes a certain time for the charge to move to the BOP. As a result, an effective charge waveform is blunted with respect to an amplifier output signal, and the margin of the charge timing decreases along with the effective pulse width (Te) with which the maximum voltage (Vtop) is obtained, which is a factor of impairing the stabilization of the side-stream trajectory. This tendency becomes more remarkable as the droplet frequency increases, that is, as the charging pulse width decreases. This tendency is hereinafter described in detail.

In the configuration shown in FIG. 6, according to the charging method C described above, a sample liquid nozzle was made of metal, and a charge signal cable was wired. The distance from a lower end of the metal sample liquid nozzle to the orifice was 28 mm in total including a linear flow path of 0.2 mm square×15 mm long in the cuvette immediately above the orifice. Then, a metal plate was attached to the orifice position, and a probe of an oscilloscope was brought into contact with the orifice to measure an effective charging pulse waveform.

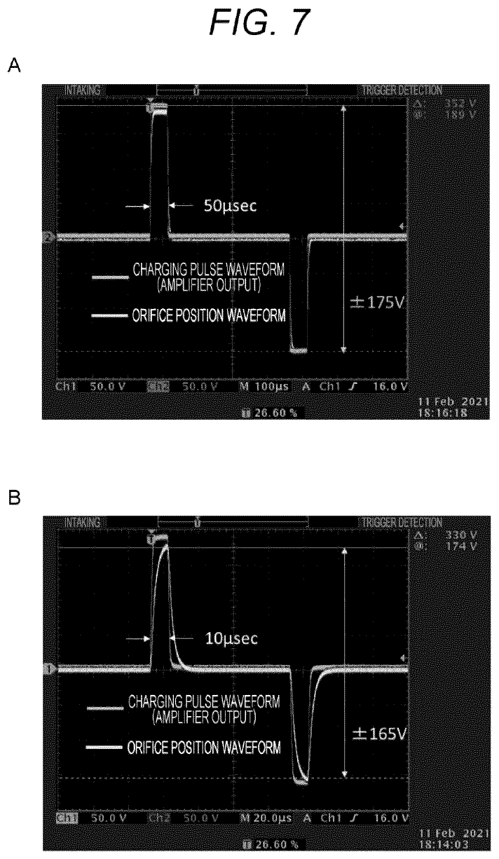

FIG. 7 illustrates a comparison result between an original signal waveform (AMP output waveform) and an effective waveform at the orifice position when a pulse of a voltage ±175 V is applied to the metal sample liquid nozzle in a state where a flow cell flow path is filled with sheath liquid. A of FIG. 7 illustrates a result when a pulse width T1 is set so as to correspond to 50 μsec=20 kHz droplet, and B of FIG. 7 illustrates a result when a pulse width T2 is set so as to correspond to 10 μsec=100 kHz droplet.

When T1=50 μsec, the rise time slightly increased with respect to the AMP output waveform, but the waveform was maintained almost without deterioration, and there was no problem. On the other hand, when T2=10 μsec, which was a shorter pulse width than T1, the rise time became approximately equal to T2. As a result, the voltage became blunt as an interval of the maximum voltage (Vtop) of the charging pulse became almost 0, and a voltage amplitude also decreased by 6%. When the side stream is formed in this state, the timing at which the deflection angle is maximized becomes pinpoint, and the deflection angle decreases according to a timing variation of about ±0.1 to 0.2T, so that it is difficult to keep the side-stream trajectory constant. Moreover, the maximum deflection angle is also insufficient with respect to the original value.

From the above, in particular, it is required to provide a technique for stabilizing the side-stream trajectory for a long time by suppressing deterioration of the charging pulse waveform in the droplets of a high frequency and performing charging as faithfully as possible to the charging pulse output waveform to secure a margin of the charge timing as wide as possible.

### 2. First Embodiment (Particle Sorting Device 1)

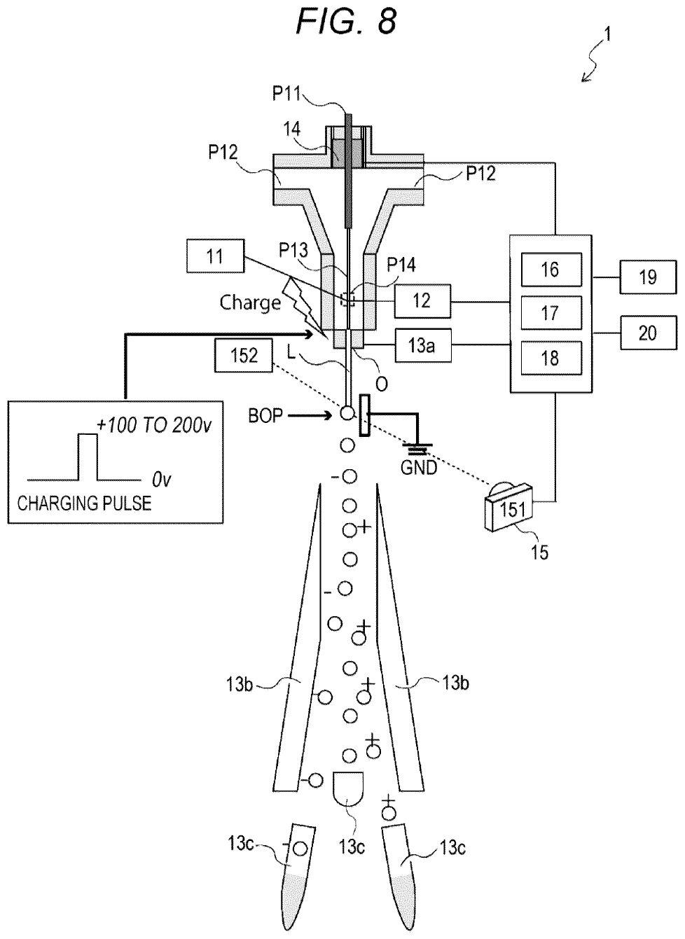

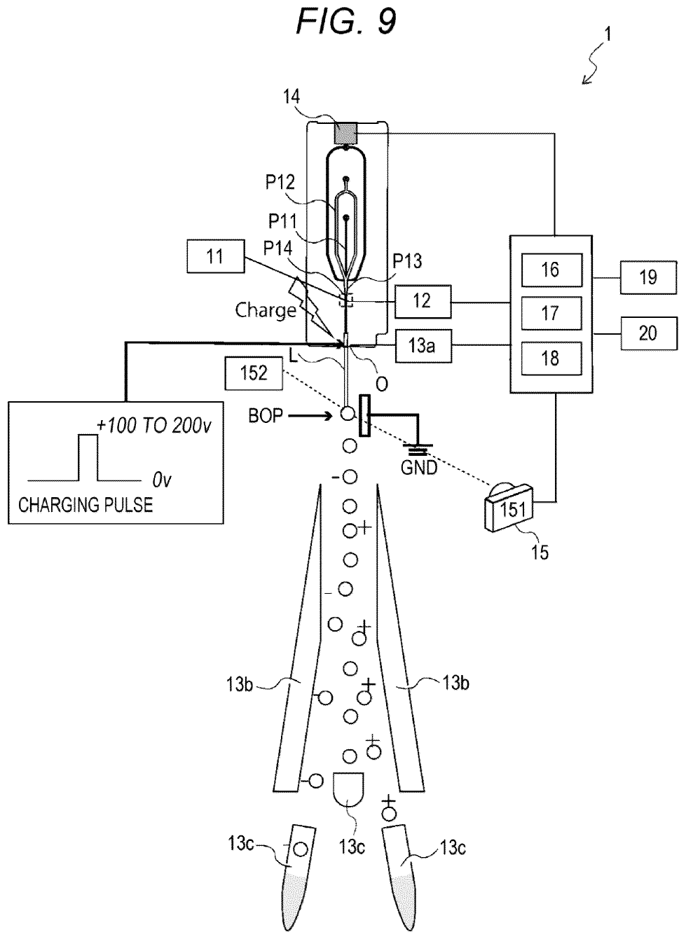

FIG. 8 illustrates a configuration example of a first embodiment of a particle sorting device 1 according to the present technology. Furthermore, FIG. 9 illustrates another configuration example of the first embodiment of the particle sorting device 1 according to the present technology.

The particle sorting device 1 illustrated in FIGS. 8 and 9 includes at least an irradiation unit 11, a detection unit 12, an orifice O, a conductive portion R, and a charging unit 13a. In addition, the particle sorting device 1 may include a flow path P, a deflector plate 13b, a recovery vessel 13c, a vibration unit 14, an imaging unit 15, a break-off control unit 16, an analysis unit 17, a storage unit 18, a display unit 19, a user interface 20, and the like as necessary.

### (1) Flow Path P

A fluid containing particles flows through the flow path P. A sample liquid containing particles and sheath liquid flowing so as to enclose the sample liquid may flow through the flow path P as necessary, and in this case, the flow path P can be configured to form a flow in which the particles are aligned in a substantially linear form. The flow path P may be provided in advance in the particle sorting device 1, but it is also possible to install a commercially available flow path, a disposable microchip provided with a flow path, or the like.

The form of the flow path P is also not particularly limited and can be freely designed as appropriate. For example, without restricting to the flow path formed in a substrate of two-dimensional or three-dimensional plastic, glass, or the like illustrated in FIG. 4, a flow path as used in a conventional flow cytometer illustrated in FIG. 3 can also be used.

The flow path width, the flow path depth, the flow path cross-sectional shape, and the like of the flow path P are also not particularly limited, and can be freely designed as appropriate. For example, a micro flow path having a flow path width of 1 mm or less can also be used in the particle sorting device 1.

In the present technology, “particles” can broadly include biologically relevant particles such as cells, microorganisms, and ribosomes, or synthetic particles such as latex particles, gel particles, and industrial particles, or the like. Furthermore, in the present technology, the particles can be contained in a fluid such as a liquid sample.

The biologically relevant particles can include chromosomes composing various cells, ribosomes, mitochondria, organelles (cell organelles), and the like. The cells can include animal cells (such as blood cells as an example) and plant cells. The microorganisms can include bacteria such as Escherichia coli, viruses such as tobacco mosaic virus, fungi such as yeast, and the like. In addition, the biologically relevant particles can also include biologically relevant polymers such as nucleic acids, proteins, and composites of these, for example.

For example, the industrial particles may be an organic or inorganic polymer material, metal, or the like. The organic polymer material can include polystyrene, styrene/divinylbenzene, polymethyl methacrylate, and the like. The inorganic polymer material can include glass, silica, magnetic material, and the like. The metal can include gold colloid, aluminum, and the like. In general, shapes of these particles are normally spherical, but may be non-spherical in the present technology, while the dimensions, mass, and the like thereof are also not particularly limited.

In the present technology, the biologically relevant particles, in particular, cells are preferable as the particles.

The particles may be labeled with one or two or more kinds of dyes such as fluorescent dyes. In this case, the available fluorescent dyes include, for example, Cascade Blue, Pacific Blue, fluorescein isothiocyanate (FITC), phycoerythrin (PE), propidium iodide (PI), Texas Red (TR), peridinin chlorophyll protein (PerCP), allophycocyanin (APC), 4′,6-diamidino-2-phenylindole (DAPI), Cy3, Cy5, Cy7, Brilliant Violet (BV421), and the like.

### (2) Irradiation Unit 11

The irradiation unit 11 irradiates a part of the flow path P, through which a fluid containing particles flows, with laser light. Specifically, the irradiation unit 11 irradiates the particles with the laser light, the particles being fed in a state of being arranged substantially in a line at the center of the three-dimensional laminar flow in a main flow path P13.

The irradiation unit 11 includes one or more light sources. In a case where the irradiation unit 11 includes a plurality of light sources, the irradiation unit 11 can be configured such that the laser light emitted from the plurality of light sources is multiplexed and then, the particles are irradiated with the multiplexed laser light. Furthermore, the irradiation unit 11 may be configured to perform irradiation with the laser light from the plurality of light sources at different positions in a flow direction of the fluid. In the present technology, each of the plurality of light sources may emit laser light with the same wavelength or may emit laser light with a different wavelength.

A type of the laser light emitted from the irradiation unit 11 is not especially limited, and examples of the laser light include a semiconductor laser, an argon ion (Ar) laser, a helium-neon (He—Ne) laser, a dye laser, a krypton (Cr) laser, a solid-state laser in which a semiconductor laser and a wavelength conversion optical element are combined, and the like, and two or more thereof can be used in combination.

Furthermore, the irradiation unit 11 may include a light-guiding optical system for guiding the laser light to a predetermined position. This light-guiding optical system may include, for example, optical components such as a beam splitter group, a mirror group, and an optical fiber. In addition, the light-guiding optical system may include a lens group for condensing the multiplexed excitation light and can include, for example, an objective lens.

### (3) Detection Unit 12

The detection unit 12 detects light generated by the irradiation of the laser light by the irradiation unit 11 described above. Specifically, the detection unit 12 detects fluorescence or scattered light (for example, forward scattered light, backward scattered light, side scattered light, Rayleigh scattering, Mie scattering, and the like) which is measurement target light emitted from the particle by irradiating the particle with laser light.

The detection unit 12 includes at least one or more photodetectors that detect the measurement target light. The photodetector includes one or more light-receiving elements, and may have a light-receiving element array, for example. Furthermore, the photodetector may include one or a plurality of photodiodes such as a photomultiplier tube (PMT), an avalanche photodiode (APD), and a multi-pixel photon counter (MPPC), as the light-receiving elements. In this case, the photodetector may be, for example, a PMT array in which a plurality of PMTs is arranged in a one-dimensional direction. Furthermore, the detection unit 12 may include an imaging element such as a charge-coupled device (CCD) or a complementary metal-oxide-semiconductor (CMOS).

The detection unit 12 includes a signal processing unit such as an A/D converter that converts an electrical signal obtained by a photodetector into light data (digital signal). The light data obtained by the conversion by the signal processing unit can be sent to the analysis unit 17 to be described later. Examples of the light data include light data including fluorescence data, and specifically include light intensity data of light including fluorescence (such as feature amounts including the area, height, and width, as an example), and the like.

Furthermore, the detection unit 12 can include a detection optical system that causes light of a predetermined detection wavelength to reach the corresponding photodetector. The detection optical system can include, for example, a spectroscopic unit such as a prism or a diffraction grating, a wavelength separation unit such as a dichroic mirror or an optical filter, or the like.

### (4) Orifice O

The orifice O is disposed at the end of the flow path P and discharges a fluid containing particles. A specific form of the orifice O will be described later in “3. Mode Example of orifice O and conductive portion R”.

### (5) Conductive Portion R

The conductive portion R is disposed at a position where the fluid containing particles is formed into droplets, that is, in the vicinity of the BOP. A specific form of the conductive portion R will be described later in “3. Mode Example of orifice O and conductive portion R”.

In the present technology, the conductive portion R preferably includes a conductive material, and examples of the conductive material include a metal such as stainless steel or titanium, a conductive resin filled with conductive filler or the like including carbon, metal powder, fiber, or the like, a non-conductor (for example, resin, ceramic, and the like) having a surface to which conductivity is imparted by depositing or sputtering a metal such as gold, platinum, nickel, or chromium, and the like.

The conductive portion R is preferably disposed downstream of an optical detection region P14, which is a region irradiated with the laser light, in a flow direction of the fluid containing the particles. Therefore, it is possible to easily arrange the conductive portion R in the vicinity of the BOP.

The present technology is a method of applying a charge signal to the orifice O closest to the BOP that is a droplet splitting position when the particles are discharged as a liquid column L from the orifice O in a cell sorter and are eventually formed into droplets. Conventionally, charging has been performed by providing a charging electrode in the vicinity of the inlet of the droplet formation unit. However, in the present technology, the charging electrode greatly approaches the BOP as compared with the installation position of the charging electrode, and a movement time of the charge or ions is reduced. Therefore, the rise/fall time of the effective charge waveform is suppressed, and the charging AMP output waveform is provided to the droplet almost without deterioration. As a result, the following effects can be obtained with respect to the side-stream trajectory.

First, in the effective charge signal, since a time (Te) while the maximum voltage (Vtop) is maintained can be taken as long as possible, the margin of the charge timing for obtaining the maximum deflection angle is also widened to the maximum. As a result, for example, in a case where a minute variation occurs in a droplet splitting timing due to a change in the sheath liquid temperature etc., or the like, the stability of the side-stream trajectory is secured.

Furthermore, in the conventional charging method, there has been a case where the pulse rise/fall time exceeds the charge signal pulse width, the charging pulse does not reach the maximum voltage (Vtop), and the original deflection angle cannot be obtained. On the other hand, in the orifice charging method of the present technology, such deterioration does not occur, and the original deflection angle can be obtained with respect to the charge signal output voltage.

In addition, since the designated charge signal is applied to the droplet without deterioration, it is possible to perform minute correction of charge voltage more precisely to each droplet according to various sort patterns, and it is easy to focus the side-stream trajectory in a certain range regardless of the pattern.

Note that these effects become more remarkable as the droplet frequency is improved, and thus are particularly useful in a case of deflecting droplets having a frequency of preferably 50 kHz or more, more preferably around 100 KHz.

### (6) Charging Unit 13a

The charging unit 13a applies a charge to the conductive portion R on the basis of the light data detected by the detection unit 12. Specifically, the charging unit 13a applies a charge signal to the conductive portion R as necessary, therefore, a positive or negative charge is applied to a desired droplet D.

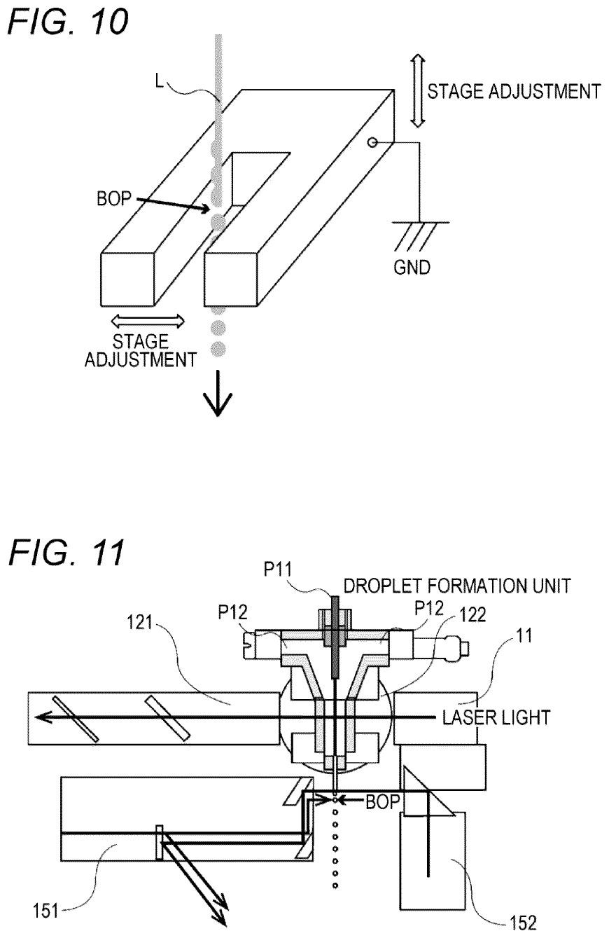

The charging unit 13a preferably includes a ground electrode disposed in the vicinity of the BOP in addition to a charging electrode that applies a charge signal. As a form of the ground electrode, for example, as illustrated in FIG. 10, a U-shaped metal member is used so as to surround the liquid column L, and the metal member can be arranged so as to approach the BOP by about 0.5 mm by adjusting a movable stage or the like. Then, the ground side of a charge signal line is connected to the electrode including the metal member to use the charging unit 13a.

Furthermore, the charging unit 13a may correct a charge amount of the droplet. Specifically, the charging unit 13a performs so-called defanning that applies a voltage corresponding to correction to the charge signal. Therefore, it is possible to prevent a zero-charged droplet group, that is, the center stream from spreading, and it is possible to narrow a waste liquid container, so that it is possible to narrow the deflection angle of the side stream accordingly. Furthermore, in a case where sorting is performed at a high frequency (for example, a case of sorting with few zero-charged droplets inserted in between, etc.), in a case where charging is continuously performed in the same direction, or the like, the side stream is also affected by the charge of the front proximity droplets, and thus, it is possible to prevent the side stream from being split by performing defanning.

### (7) Deflector Plate 13b, Recovery Vessel 13c

The deflector plate 13b controls a traveling direction of a desired droplet D depending on the presence or absence of an electrical force and the magnitude thereof, and guides the droplet D to the predetermined recovery vessel 13c.

Specifically, the deflector plates 13b deflect the traveling direction of each droplet D in a fluid stream by an electrical force acting between the positive or negative charges applied to the droplets D, and guide the droplet D to the predetermined recovery vessel 13c, and are disposed to face each other across the fluid stream. The deflector plate 13b is not particularly limited, and conventionally known electrodes and the like can be used. Positive or negative different voltages are applied to the deflector plates 13b, and when the charged droplet D passes through an electric field formed by them, an electric force (Coulomb force) is generated, and each droplet D is attracted in a direction toward either deflector plate 13b.

The plurality of recovery vessels 13c can be arranged in a substantially linear form in the facing direction of the deflector plate 13b. The recovery vessel 13c is not particularly limited, and examples thereof include a plastic tube, a glass tube, and the like. The number of recovery vessels 13c is also not particularly limited, and FIGS. 8 and 9 each illustrate an example in which three recovery vessels are installed. Note that the recovery vessel 13c may be installed in a recovery vessel container (not illustrated) in a replaceable manner. Specifically, for example, the recovery vessel container can be disposed on a Z-axis stage (not illustrated) configured to be movable in a direction orthogonal to the discharging direction of the droplet D from the orifice O and the facing direction of the deflector plates 13b.

### (8) Vibration Unit 14

The vibration unit 14 applies vibration to the fluid by supplying a driving voltage based on one or a plurality of frequencies. Therefore, the fluid can be continuously formed into droplets to generate a fluid stream. The frequency may be a frequency domain designated by a user.

The vibration is applied by, for example, a vibrating element. The vibrating element is not particularly limited, and conventionally known vibrating elements, for example, a piezoelectric element and the like can be used. In a case where a chip is used as the flow path P, the vibrating element is preferably provided near an orifice O of the chip.

In the case of the flow cell system as illustrated in FIG. 3, the sheath liquid and the sample liquid are firstly injected into a conical container. The conical container is installed with its apex facing vertically downward, and a tube or the like for introducing the sheath liquid is connected to an upper side surface. An upper surface of the conical container is open, and a vibrating element is attached in a sealed state with an O-ring. The sample liquid is vertically injected from above the container, the vibrating element and a piston have an annular shape, and a pipe passes through a center hole thereof. The conical container narrows at the lowermost portion, and its tip is connected to a cuvette portion in which the main flow path (linear flow path) P13 is formed. When a laminar flow is formed so that the sheath liquid surrounds the sample liquid in the conical container and the sample liquid travels to the cuvette portion as a laminar flow as it is, detection by laser light irradiation is performed in the main flow path P13. A detachable outlet nozzle is installed at the endpoint of the main flow path P13, and has a sloped shape to be continuously narrowed from the cuvette outlet to the orifice O. The sheath liquid and the sample liquid are slightly vibrated in the front-rear direction with respect to the flow, from the vibrating element attached immediately above the conical container. Then, the liquid column L ejected from the orifice O travels vertically downward while widening a crack formed at the same frequency as the vibration produced by the vibrating element, and is formed into droplets at the BOP that is a position 10 to 20 mm from the orifice O.

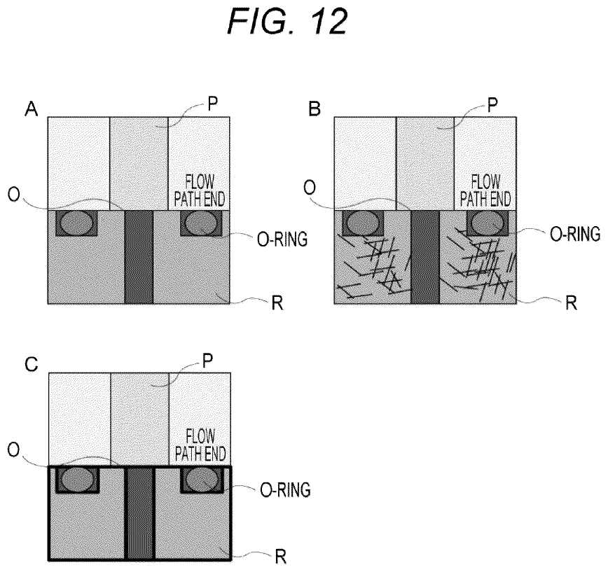

FIG. 11 illustrates a configuration example of an optical system around a droplet formation unit in the case of the flow cell system. A droplet camera 151 and a strobe 152 constituting the imaging unit 15, a forward scattered light detector 121 and a side fluorescence detector 122 constituting the irradiation unit 11 and the detection unit 12, and the like are provided around the droplet formation unit.

In the case of the chip system as illustrated in FIG. 4, a sheath liquid inlet and a sheath liquid flow path P12, a sample liquid inlet and a sample liquid flow path P11, a main flow path (linear flow path) P13 where these flow paths merge and light is emitted, the orifice O, and the like are integrated and are replaceable. The sample liquid flow path P11 is linearly disposed at the center, and the sheath liquid flow path P12 branches to the left and right from the inlet so as to surround the sample liquid flow path P11, and the three flow paths eventually merge at one position to become the main flow path P13. As a result, a laminar flow is formed so that the sample liquid is sandwiched by the sheath liquid, and travels to an optical detection region P14 where detection by laser light irradiation is performed. Moreover, an annular flow path P15 is disposed in the outermost peripheral portion and is connected to the main flow path P13 from the left and right, and the flow path is connected to an external pump and used to remove bubbles generated in the flow path. In this case, in a case where vibration is applied to a portion of a substrate surface forming the chip by the vibrating element, the droplet D is formed from the liquid column L ejected from the orifice O. Alternatively, the sheath liquid may be directly vibrated before the inlet of the chip.

### (9) Imaging Unit 15

In the BOP, the imaging unit 15 acquires an image of the fluid before being formed into droplets and the droplet D.

Examples of the imaging unit 15 include a droplet camera 151, such as a charge-coupled device (CCD) camera or a complementary metal-oxide-semiconductor (CMOS) sensor, and the like. The droplet camera 151 can be disposed at a position where the droplet D can be imaged between the orifice O and the deflector plate 13b. Furthermore, the droplet camera 151 can adjust the focus of the captured image of the droplet D. Examples of a light source that illuminates the imaging region in the droplet camera 151 include a strobe 152 and the like. Note that the imaging unit 15 can also obtain a photograph of a phase at a certain time, and can continuously obtain the photograph within a certain cycle. The “certain cycle” mentioned here is not particularly limited, and may be one cycle or a plurality of cycles. In the case of a plurality of cycles, each cycle may be temporally continuous or discontinuous.

The image captured by the imaging unit 15 is displayed on the display unit 19 to be described later, and can be used by the user to confirm the formation status of the droplet D (for example, size, shape, spacing, etc. of the droplet D). Furthermore, the strobe 152 may be controlled by the break-off control unit 16 to be described later. The strobe 152 includes, for example, a light-emitting diode (LED) for imaging the droplet D and a laser (for example, red laser light source, etc.) for imaging the particles, and can be switched by the break-off control unit 16 to be described later according to the purpose of imaging or the like. The specific structure of the strobe 152 is not particularly limited, and conventionally known circuits and/or elements can be used.

### (10) Break-Off Control Unit 16

The break-off control unit 16 controls the break-off of the droplet D containing the target particle on the basis of the image of the state of the droplet D containing the particle acquired by the imaging unit 15 described above. Specifically, the driving voltage of the vibrating element is adjusted on the basis of the break-off timing of the droplet D containing the particles specified by a plurality of droplet observation images captured by the imaging unit 15, whereby the bonding state between the droplet D and the liquid column L and/or the distance between the droplet D and the liquid column L and the break-off position of the droplet D are controlled to remain constant. As a result, by constantly applying feedback to the driving voltage to adjust the droplets, it is possible to prevent instability of the droplet D after the start of sorting.

### (11) Analysis Unit 17

The analysis unit 17 is connected to the detection unit 12, the imaging unit 15, and the like, and performs analysis on the basis of light data acquired by the detection unit 12, an image acquired by the imaging unit 15, and the like.

Specifically, the analysis unit 17 calculates the feature amount of each particle on the basis of the light data acquired by the detection unit 12. For example, the feature amount, such as the size, form, and internal structure of the particle, is calculated from the detection value of the received fluorescence or scattered light. Furthermore, a sorting control signal is generated by performing sorting determination on the basis of the calculated feature amount, a sorting condition received from the user interface 20 described later, and the like. By applying a charge signal to the charging unit 13a described above on the basis of the sorting control signal, particles of a specific type can be sorted and collected. Furthermore, the analysis unit 17 analyzes or calculates the data regarding the state of the droplet D from the image acquired by the imaging unit 15.

In the present technology, the analysis unit 17 may be included in a housing provided with the detection unit 12 and the like, or may be located outside the housing. Furthermore, the analysis unit 17 is not essential in the particle sorting device 1 according to the present embodiment, and an external analysis device or the like can also be used. In addition, the analysis unit 17 may be connected to each unit of the particle sorting device 1 via a network.

### (12) Storage Unit 18

The storage unit 18 stores all items such as light data detected by the detection unit 12, for example, a feature amount of each particle calculated by the analysis unit 17, a generated sorting control signal, and a sorting condition input by the user interface 20.

In the present technology, the storage unit 18 may be included in a housing provided with the detection unit 12 and the like, or may be located outside the housing. Furthermore, the storage unit 18 is not essential in the particle sorting device 1 according to the present embodiment, and an external storage device (e.g., a hard disk, etc.) or the like can also be used. In addition, the storage unit 18 may be connected to each unit of the particle sorting device 1 via a network.

### (13) Display Unit 19

The display unit 19 can display all items, and for example, can display the feature amount of each particle calculated by the analysis unit 17 as a histogram or the like. Furthermore, an image or the like captured by the imaging unit 15 may be displayed.

The display unit 19 is not essential in the particle sorting device 1 according to the present embodiment, and an external display device (e.g., display, printer, personal digital assistant, etc.) or the like can also be used. In addition, the display unit 19 may be connected to each unit of the particle sorting device 1 via a network.

### (14) User Interface 20

The user interface 20 is a part to be operated by the user. The user can input various data via the user interface 20 and access each unit of the particle sorting device 1 to control each unit. Specifically, for example, a region of interest can be set for a histogram or the like displayed on the display unit 19 via the user interface 20, and a sorting condition and the like can be determined.

The user interface 20 is not essential in the particle sorting device 1 according to the present embodiment, and an external operating device (e.g., a mouse, a keyboard, a personal digital assistant, etc.) or the like can also be used. In addition, the user interface 20 may be connected to each unit of the particle sorting device 1 via a network.

### (15) Others

Note that a function performed in each unit of the particle sorting device 1 according to the present technology can also be stored as a program in a general-purpose computer, a control unit including a CPU and the like, and a hardware resource including a recording medium and the like such as non-volatile memory (e.g., USB memory, etc.), HDD, and CD, and the function can be executed. Furthermore, the function may be realized by a server computer or a cloud connected via a network.

### 3. Mode Example of Orifice O and Conductive Portion R

Mode examples of an orifice O and a conductive portion R will be described below with reference to the drawings.

FIGS. 12 to 14 schematically illustrates various mode examples of the orifice O and the conductive portion R. FIGS. 12 and 13 are mode examples in the case of the flow cell system, and FIG. 14 is a mode example in the case of the chip system.

### (1) Mode Example in Case of Flow Cell System

A of FIG. 12 illustrates a mode example in which an orifice O including metal and a conductive portion R including metal and carrying the orifice O are brought into contact with a cuvette flow path end, through which a fluid containing particles flows, via a seal member such as an O-ring. Furthermore, B of FIG. 12 is different from the mode example illustrated in A of FIG. 12 in that the orifice O and the conductive portion R include a resin to which conductivity is imparted by conductive filler. Moreover, C of FIG. 12 is different from the mode example illustrated in A of FIG. 12 in that conductivity is imparted to the orifice O and a part of the conductive portion R including a non-conductor such as a resin or ceramic by, for example, depositing or sputtering metal.

In the mode examples illustrated in B and C of FIG. 12, since manufacture cost can be lower than that in the mode example illustrated in A of FIG. 12, the orifice O or the entire conductive portion R that supports the orifice O can be replaced.

D of FIG. 13 is a mode example in which the orifice O includes a non-conductor such as a resin or ceramic, the conductive portion R including metal is provided between the cuvette flow path end and the orifice O, and the conductive portion R is adhered so as to abut on the orifice O. In the mode example illustrated in D of FIG. 13, since the orifice O itself can include a non-conductor, options of materials and manufacturing methods can be expanded. Furthermore, in this case, since the orifice O can be manufactured at low cost, the orifice O can be disposable.

E of FIG. 13 is different from the mode example illustrated in A of FIG. 12 in that the orifice O and the conductive portion R carrying the orifice are pressed with a metal cover. The orifice O and the conductive portion R can be fixed by the cover, and further, power can be supplied to the orifice O and the conductive portion R through the cover. Note that in the present mode example, the cover may include not only metal but also another conductive material.

F of FIG. 13 is different from the mode example illustrated in A of FIG. 12 in including a cover, a positioning mechanism for attachment to the flow path end, and a metal contact probe. Note that in the present mode example, the cover and the positioning mechanism do not necessarily have conductivity. The contact probe may function as a contact having elasticity by a spring or the like, therefore, the orifice O can be easily installed at the flow path end in conjunction with the positioning mechanism. Note that in the present mode example, the contact probe may include not only metal but also another conductive material.

Note that in the mode examples illustrated in FIGS. 12 and 13, the conductive portion R may have a connection portion R1 connected to the charging unit 13a, but the charging unit 13a may be directly connected to the conductive portion R. Furthermore, in a case where the conductive portion R is replaceable, the conductive portion R may have a holding portion R2 held by a user at the time of replacement.

### (2) Mode Example in Case of Chip System

G of FIG. 14 illustrates a mode example in which the entire chip includes a conductive material. In this mode example, the orifice O itself functions as the conductive portion R by providing conductivity to a part or the whole of the orifice O. Furthermore, this mode example is effective in the case of employing “jet-in-air system” in which irradiation of the particle with the laser light is performed in the liquid column portion after the sheath liquid containing the particle is discharged from the orifice O.

H of FIG. 14 illustrates a mode example in which the optical detection region P14 of the chip includes an optically detectable material such as quartz or a transparent resin, and the other portions include a conductive material. Also in this mode example, the orifice O itself functions as the conductive portion R. Therefore, optical detection can be performed in the chip.

I of FIG. 14 illustrates a mode example in which the entire chip includes an optically detectable material, and a metal thin film is formed near the orifice O by vapor deposition, sputtering, or the like. Also in this mode example, the orifice O itself functions as the conductive portion R. Therefore, the chip including the orifice O can be manufactured at low cost, and the chip partially including the orifice O having conductivity can be disposable.

### (3) Orifice Unit U for Particle Sorting Device

The present technology also provides an orifice unit U for a particle sorting device, including an orifice O that is partially or entirely conductive and a conductive portion R that supports the orifice O.

On the basis of the mode examples illustrated in FIGS. 12 and 13 described above, an embodiment of the orifice unit U according to the present technology will be described in detail below with reference to the drawings.

### (3-1) First Embodiment of Orifice Unit U

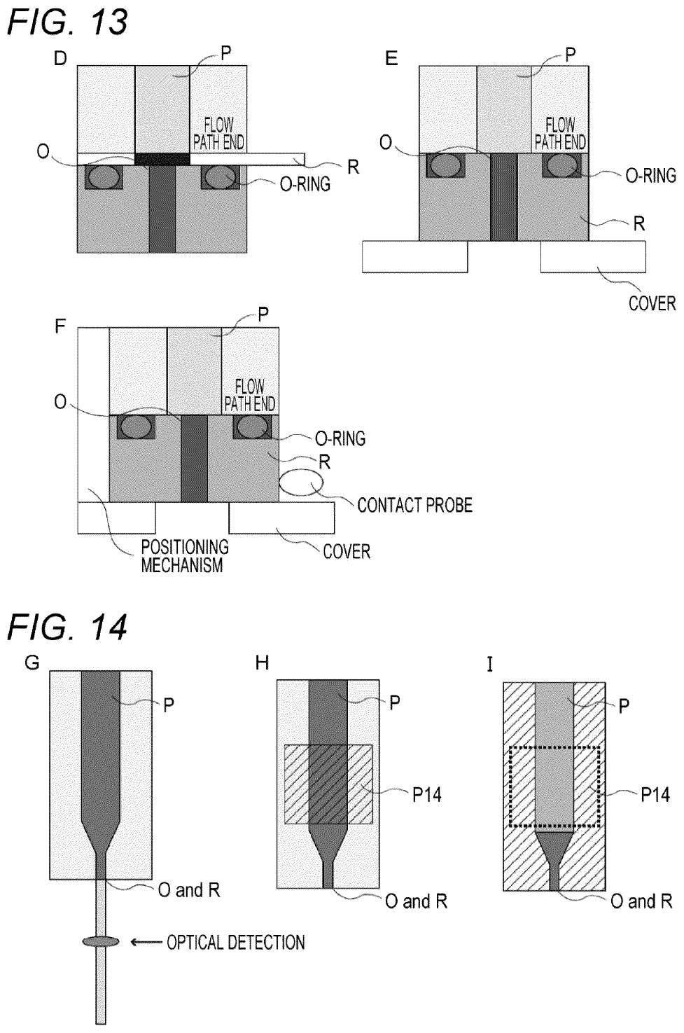

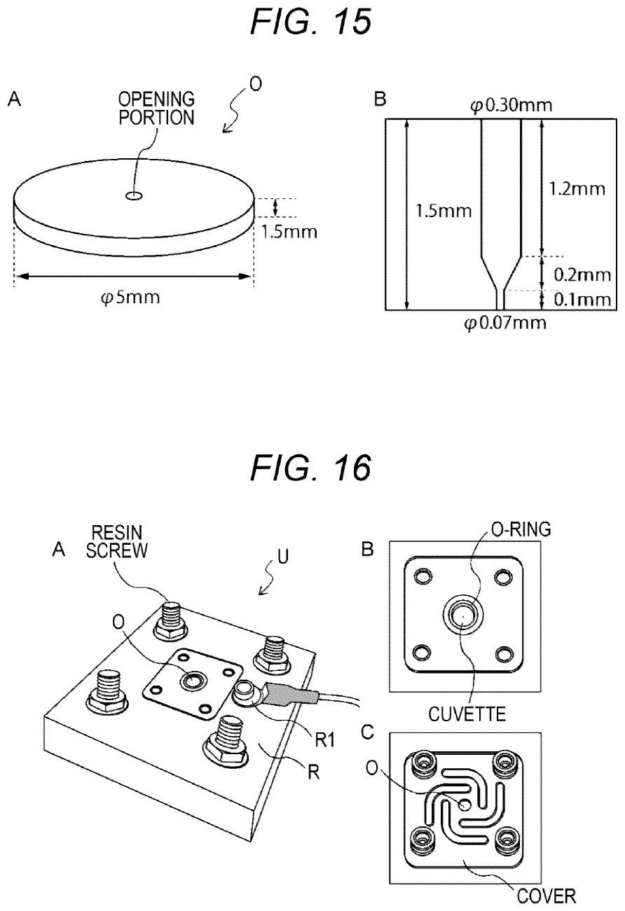

FIG. 15 illustrates an orifice O according to a first embodiment of an orifice unit U for a particle sorting device. The orifice O shown in FIG. 15 is a chip type, and the entire orifice O includes a conductive material. Specifically, for example, as illustrated in A of FIG. 15, an opening portion is processed at the center of a chip having an outer diameter of 5 mm and a thickness of 1.5 mm. Furthermore, as illustrated in B of FIG. 15, the orifice O is provided with a circular flow path having a diameter of p 0.3 mm in a length of 1.2 mm with respect to a main flow path (linear flow path) P13 before the orifice O so as to be continuous with the main flow path P13, a slope portion narrowing down from p 0.3 mm to p 0.07 mm is inserted in the tip thereof with a length of 0.2 mm, and a nozzle portion having a diameter of p 0.07 mm as an endpoint is formed with a length of 0.1 mm.

Furthermore, FIG. 16 illustrates the orifice O and a conductive portion R according to the first embodiment. A of FIG. 16 illustrates a state in which the orifice O is attached to the conductive portion R, B of FIG. 16 illustrates a state before the orifice O is attached, and C of FIG. 16 illustrates a state in which the orifice O is attached while being pressed by a cover including a conductive material. As illustrated in FIG. 16, the metal conductive portion R is disposed on a bottom surface portion of a droplet formation unit so as to support the orifice O. In this case, as illustrated in A of FIG. 16, the conductive portion R has at an end portion thereof a connection portion R1 connected to the charging unit 13a. It is important that the conductive portion R itself is electrically completely separated from the ground, and for example, the conductive portion R is attached to the droplet formation unit with a resin screw via an insulating resin block or the like.

In the present embodiment, the orifice O is replaceable, and is stacked in a through hole of the conductive portion R on an end portion of the main flow path P13 via, for example, an O-ring or the like. Then, in a state of being attached so as to form a minute protruding step from a surface of the through hole, the orifice O is pressed by a cover and fixed with a screw or the like as illustrated in C of FIG. 16. With this cover, conduction between the conductive portion R and the orifice O is sufficiently secured, and a charge signal from the charging unit 13a is applied to the orifice O via the connection portion R1. Note that a method of fixing the replaceable orifice O is not limited to the method using the cover described above, and other methods may be adopted in view of convenience of the user.

### (3-2) Second Embodiment of Orifice Unit U

The orifice O illustrated in the first embodiment described above is slightly difficult to handle during the attaching and detaching operation, and the possibility of contamination increases when directly touched with a hand. Therefore, in the present embodiment, an orifice unit U in which an orifice O is attached to a holder-type conductive portion R that supports the orifice O is formed, the entire orifice unit U is replaceable, and an attachment operation and a detachment operation are performed on a droplet formation unit. Therefore, the orifice O and the conductive portion R can be integrally attached and detached, and user convenience is improved. At that time, by forming a part or all of the orifice O and the conductive portion R with a conductive material, the conductive portion R has a structure electrically connected to the orifice O, and when the conductive portion R is connected to a charging unit 13a, the orifice O can be charged.

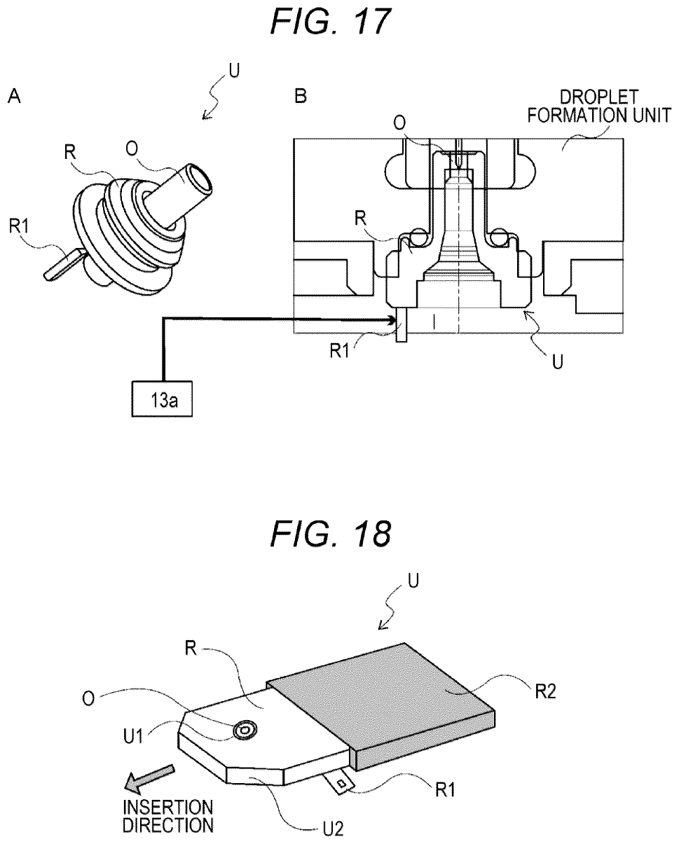

The conductive portion R illustrated in A of FIG. 17 includes metal, for example, and has a structure in which the chip-type orifice O is set at the tip. Furthermore, a connection portion R1 connected to the charging unit 13a is provided on the opposite surface (an outlet side of a liquid column L). Furthermore, as illustrated in A of FIG. 17, the conductive portion R has a screw groove cut on a side surface thereof, and can be attached to the liquid droplet formation unit in a screwing manner as illustrated in B of FIG. 17. Note that regarding the connection position with the charging unit 13a, the conductive portion R may be connected to the charging unit 13a on the droplet formation unit main body side without providing the connection portion R1. In this case, as in the first embodiment described above, a portion in contact with the orifice unit U may include a conductive material, and a charge signal may be connected to the conductive material so as to be conductive thereto.

### (3-3) Third Embodiment of Orifice Unit U

In the present embodiment, an orifice unit U including an orifice O and a conductive portion R that supports the orifice O and formed in a card shape is manufactured, and attached to a flow path end, through which a fluid containing particles flows, in a lateral insertion manner into a predetermined gap like a memory card. In a plane of the card-shaped orifice unit U, for example, as illustrated in FIG. 18, a structure including an opening portion which is an orifice O and a groove U1 for mounting an O-ring formed in an outer peripheral portion thereof is provided. Furthermore, a positioning mechanism may be provided by providing a positioning tapered structure U2 or the like on the end surface of the orifice unit U, for example, so that the orifice O can be accurately disposed with respect to the flow path end. The orifice unit U of the present embodiment can also be replaceable, and in this case, a holding portion R2 held by the user at the time of replacement may be provided on the side opposite to an insertion direction side.

In the present embodiment, the entire surface of the conductive portion R or a part of the surface including the orifice O includes a conductive material and is electrically connected to the connection portion R1, so that a charge signal can be applied. Note that regarding the connection position with a charging unit 13a, as in the second embodiment described above, the conductive portion R may be connected to the charging unit 13a on the droplet formation unit main body side without providing the connection portion R1. In this case, as in the first embodiment described above, a portion in contact with the orifice unit U may include a conductive material, and a charge signal may be connected to the conductive material so as to be conductive thereto.

### (3-4) Fourth Embodiment of Orifice Unit U

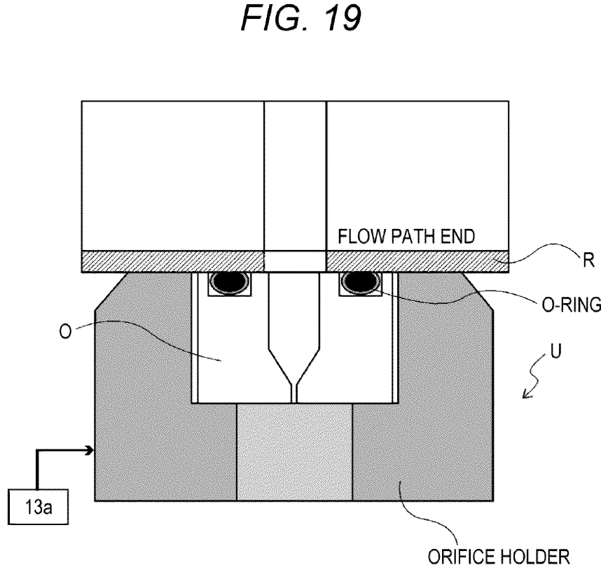

In the present embodiment, a conductive portion R is formed so as to abut on an orifice O with respect to a flow path end through which a fluid containing particles flows, and charging is performed at the flow path end, that is, an inlet of the orifice O, instead of charging the orifice O itself. Specifically, as illustrated in FIG. 19, the thin film-shaped conductive portion R having substantially the same opening shape is bonded to an end surface of the flow path end such that sheath liquid is in direct contact with the end surface. Then, the conductive portion R is configured so as to be electrically connected to a flow path holding member or an orifice holding member (orifice holder), and a charge signal is supplied to the flow path end through the conductive portion R. The conductive portion R can be, for example, a conductive thin film electrode, and the electrode may include metal, and a metal thin film may be formed by vapor deposition, sputtering, plating coating, or the like so that the electrode is also formed on a side wall in the vicinity of the flow path end.

In the present embodiment, the charge position is away from the BOP by about 1 to 2 mm with respect to the outlet of the orifice O, but since the deviation is about 10% of the distance from the outlet to the BOP which is about 10 to 20 mm, an effect substantially equal to that of each of the above-described embodiments can be obtained. Furthermore, in the present embodiment, since it is possible that the orifice O itself does not have conductivity, the orifice O can include a non-conductor such as a resin or ceramic, and options of materials and manufacturing methods can be widened. Furthermore, in this case, since the orifice O can be manufactured at low cost, the orifice O or the entire orifice holder holding the orifice can be disposable. Note that the orifice holder may have a holding portion R2 held by the user at the time of replacement.

### (4) Embodiment in Case of Chip System

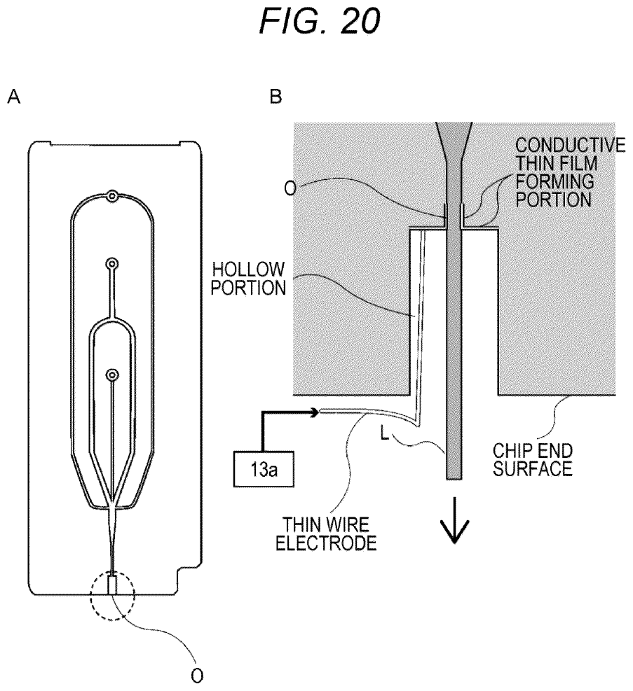

The present embodiment assumes the case of the chip system illustrated in A of FIGS. 4 and 20.

In the chip system, since a chip includes an inexpensive resin or the like on the premise of disposable use, it is insulating, and therefore it is necessary to perform a conductive treatment to an orifice O so as to contact sheath liquid. In the chip illustrated in A of FIGS. 4 and 20, the outlet of the orifice O is not disposed on the chip end surface, and a hollow portion is formed from the tip of the orifice O to the chip end surface. Therefore, vapor deposition or sputtering is performed in a state where a mask is applied to the chip surface or the end surface such that a conductive material such as gold, platinum, nickel, or chromium is formed from the end surface of the orifice O to the inner side wall of the flow path. As described above, in the present technology, in the case of the chip system, the orifice O itself functions as the conductive portion R by providing conductivity to a part or the whole of the orifice O.

B of FIG. 20 is an enlarged view of a broken line portion in A of FIG. 20. In the present embodiment, a structure is provided in which a thin line-shaped electrode is provided in a main-body-side chip loader unit so that a charge signal is applied to a conductive thin film forming portion of the orifice O, and when the chip is loaded, the electrode enters the chip end face hollow portion and comes into contact with the conductive thin film forming portion. The thin line-shaped electrode is electrically connected to the charging unit 13a, and the sheath liquid is charged through the electrode at the orifice O in the chip. In the present embodiment, a position adjustment mechanism may be provided so that the thin line-shaped electrode does not come into contact with a liquid column L discharged from the orifice O in the hollow portion.

By the above-described method, the present technology can also be applied to the case of the chip system, but is not limited to the above-described embodiment, and other modes can also be used. For example, a method is also conceivable in which a metal electrode is inserted near the orifice O by insert molding, a hole is provided on the chip surface, and a charge signal is supplied to the metal electrode.

### 4. Second Embodiment (Particle Sorting Method)

A particle sorting method according to the present embodiment performs at least an irradiation step, a detection step, and a charging step. Furthermore, other steps may be performed as necessary. Note that a specific method performed in each step is similar to the method performed in each unit of the particle sorting device 1 according to the first embodiment described above, and thus the description thereof is omitted here.

### EXAMPLES

The present technology will be described in more detail below on the basis of examples. Note that examples to be described below illustrate examples of representative embodiments of the present technology, and the scope of the present technology is not narrowed by them.

As an example, a particle sorting device having a configuration illustrated in FIG. 8 was used, and a side stream was formed with respect to a droplet having a droplet frequency of 100 kHz using a pulse having a width of 10 μsec corresponding to one cycle (T) while gradually changing the charge timing.

On the other hand, as a comparative example, a result in a case where a charge signal is connected to a sheath liquid tube attachment portion at a position where the sheath liquid is injected into the droplet formation unit as shown in FIG. 6, that is, a result in the conventional charging method A was prepared.

Detailed experimental conditions are described below.
Droplet frequency: 100 kHz
Charge signal
Pattern: Repeat positive and negative once every fifth droplet cycle
*Repeat [+_0_0_0_0_-_0_0_0_0]
Pulse width: T=10 μsec at signal generation source
Pulse voltage: ±160 V
Deflector plate voltage: ±4.5 kV (inlet linear portion interval: 8 mm)

First, in the charging method (Example) according to the present technology and the conventional charging method A (Comparative Example), a charge waveform was observed by bringing a probe of an oscilloscope into contact with an aluminum block to which an orifice is attached.

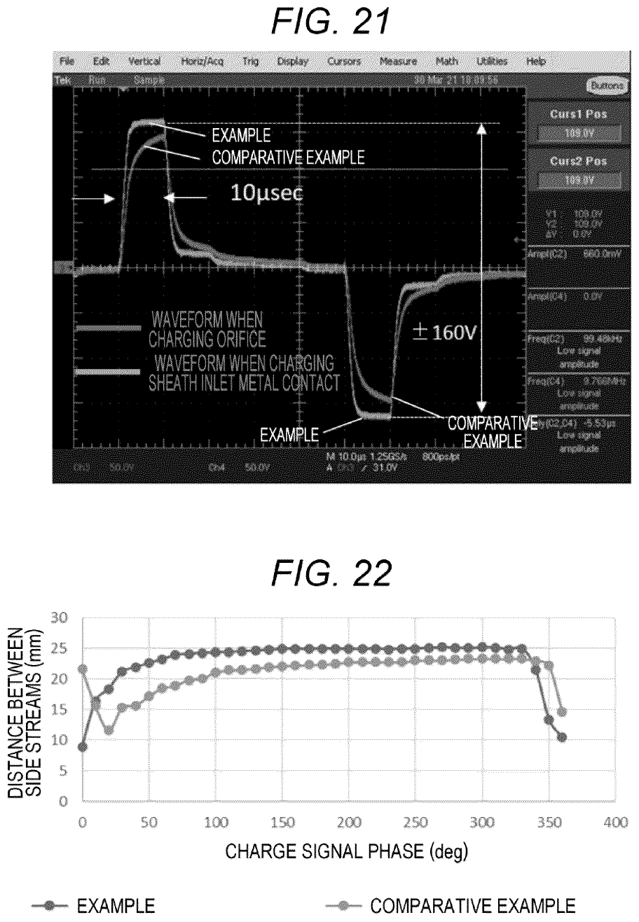

FIG. 21 illustrates a comparison result of charge signal waveforms of Example and Comparative Example.

Similarly to the example illustrated in B of FIG. 7, in Comparative Example, a significant increase in rise time (Tr) and fall time (Tf) of a signal was observed, and the time(Te) while the maximum voltage (Vtop) was maintained was almost zero. Furthermore, the maximum voltage (Vtop) was also reduced by about 10% with respect to Example.

Next, for each of Example and Comparative Example, while the phase of the charging pulse was rotated by 360° at 100 steps, the distance between the two side streams split to the left and right on the positive side and the negative side was measured. The measurement point was a point 170 mm below the upper end of the deflector plate.

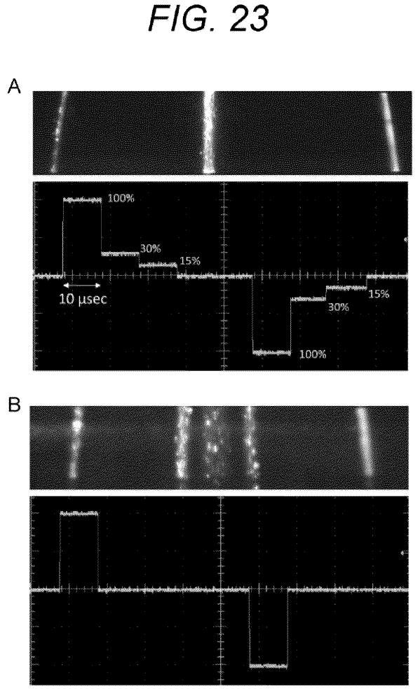

FIG. 22 illustrates a comparison result of a relationship between the side stream deflection distance and the charge signal phase in Example and Comparative Example.

In Example, the charge phase indicating the maximum deflection distance of 25 mm occupied about ⅔ of one cycle, and in particular, in the range of 1800 (half cycle) from the phase of 1500 to 330°, almost no variation was observed.

On the other hand, in Comparative Example, the deflection distance gradually varied upward with respect to the progress of the charge phase, and the phase range in which the maximum deflection distance was maintained decreased to 130° from 2000 to 330°. That is, a margin of charge timing was reduced to about 70% of Example. Furthermore, the maximum deflection distance was also reduced by 10% with respect to Example.

It can be said that the result illustrated in FIG. 22 reflects the state of degradation of the charge waveform in FIG. 21. Therefore, it has been confirmed that in a case where the supply point of the charge signal is changed to the orifice closest to the BOP in the droplet formation unit, the charge signal output waveform can be transmitted to the tip of the liquid column L almost without deterioration, and the margin of the charge timing and the deflection angle are improved.

Note that in the case of the conventional charging method, the degree of signal deterioration varies depending on conditions such as the structure and dimensions of the droplet formation unit and the position of the charging electrode, and there may be a case where a more significant adverse effect is exerted than in this experimental example. Furthermore, as the droplet frequency further increases, the margin of the charge timing absolutely decreases. On the other hand, in the present technology, ideal droplet charging can be always performed without depending on the design of the droplet formation unit.

Furthermore, even in a case where voltage correction is applied to a charging pulse according to a sorting pattern in actual sorting, the present technology contributes to higher accuracy and has an effect of focusing a side-stream trajectory within a desired range. Specifically, when the droplet is charged, a minute amount of charge in which the positive and negative polarities are reversed is also induced for the subsequent droplet by an electrostatic induction phenomenon. For example, in a case where a positive charge of Q is given to a certain droplet, a negative charge of 0.2×Q is accumulated in the next droplet, and a negative charge of 0.05×Q is accumulated in the second droplet. This phenomenon is one factor of difficulty in maintaining the side-stream trajectory constant in actual sorting.

Therefore, defanning in which a voltage corresponding to correction is applied to the charge signal is generally performed. In the charge waveform illustrated in FIG. 21, after the application of positive or negative charge of I (V), negative or positive charge of 0.1I (V) is applied to the zero-charged droplet one droplet behind instead of the original 0 (V), and negative or positive charge of 0.0251 (V) is applied to the zero-charged droplet two droplets behind, so that correction is performed such that the zero-charged droplets correctly converge to the center.

FIG. 23 illustrates a comparison result of charge waveforms related to correction of a charge signal. A of FIG. 23 illustrates a charge waveform in a case where the charge signal is corrected, and B of FIG. 23 illustrates a charge waveform in a case where the charge signal is not corrected.

In Comparative Example, since the falling waveform from ±I (V) is superimposed on the signal after the charging pulse, the original correction intention cannot be correctly reflected. In actual sorting, it is necessary to perform charging in a wide variety of random patterns such as three or more times of continuous sorting in the same direction instead of the repeated pattern as in the present experimental example, and thus, it is necessary to finely perform highly accurate charge amount correction in order to constantly converge the side-stream trajectory. Therefore, by using the present technology, it is possible to substantially faithfully apply the voltage corresponding to the correction to the charge signal, and in particular, the higher the droplet frequency, the more the effect is exhibited.

Note that the present technology can also adopt the following configurations.

[1]

A particle sorting device including:
an irradiation unit that irradiates a part of a flow path through which a fluid containing particles flows with laser light;
a detection unit that detects light generated by irradiation of the laser light;
an orifice that is disposed at an end of the flow path and discharges the fluid;
a conductive portion disposed in a vicinity of a position where the fluid is formed into a droplet; and
a charging unit that applies a charge to the conductive portion on the basis of light data detected by the detection unit.
   [2]

The particle sorting device according to [1], in which a part or all of the orifice has conductivity.

[3]

The particle sorting device according to [2], in which the conductive portion supports the orifice.

[4]

The particle sorting device according to [3], in which the orifice is replaceable.

[5]

The particle sorting device according to [4], in which the conductive portion is replaceable.

[6]

The particle sorting device according to [5], in which the conductive portion includes a holding portion held by a user at a time of replacement.

[7]

The particle sorting device according to any one of [2] to [6], in which the conductive portion includes a connection portion connected to the charging unit.

[8]

The particle sorting device according to [1] or [2], in which the conductive portion is disposed so as to abut on the orifice.

[9]

The particle sorting device according to any one of [2] to [7], in which the orifice is formed in a replaceable chip.

[10]

The particle sorting device according to any one of [1] to [9], further including a ground electrode disposed in a vicinity of a position where the fluid is formed into a droplet, in which
the charging unit applies a charge to the ground electrode.
   [11]

The particle sorting device according to any one of [1] to [10], in which the charging unit corrects a charge amount of a droplet.

[12]

The particle sorting device according to any one of [1] to [11], in which the conductive portion is disposed downstream of a region irradiated with the laser light in a flow direction of the fluid.

[13]

The particle sorting device according to any one of [1] to [12], in which the conductive portion is formed of one or more conductive materials selected from a group including a metal, a conductive resin, and a non-conductor having a surface to which conductivity is imparted.

[14]

The particle sorting device according to any one of [1] to [13], in which the particle includes a cell.

[15]

An orifice unit for a particle sorting device, including:
an orifice that is partially or entirely conductive; and
a conductive portion that supports the orifice.
   [16]

The orifice unit for the particle sorting device according to [15], further including a holding portion held by a user at a time of replacement.

[17]

The orifice unit for the particle sorting device according to [15] or [16], in which the conductive portion includes a connection portion connected to a charging unit that applies a charge to the conductive portion.

[18]

The orifice unit for the particle sorting device according to any one of [15] to [17], that is attached in a screwing manner or a lateral insertion manner to an end of a flow path through which a fluid containing sheath liquid flows.

[19]

The orifice unit for the particle sorting device according to any one of [15] to [18], further including a positioning mechanism for attachment to an end of the flow path.

[20]

A particle sorting method including:
an irradiation step of irradiating a part of a flow path through which a fluid containing particles flows with laser light;
a detection step of detecting light generated by irradiation of the laser light; and
a charging step of applying a charge to a conductive portion disposed in a vicinity of a position where the fluid is formed into a droplet on the basis of light data detected by the detection unit.

### REFERENCE SIGNS LIST

1 Particle sorting device
11 Irradiation unit
12 Detection unit
121 Forward scattered light detector
122 Side scattered light detector
13a Charging unit
13b Deflector plate
13c Recovery vessel
14 Vibration unit
141 Vibrating element
15 Imaging unit
151 Droplet camera
152 Strobe
16 Break-off control unit
17 Analysis unit
18 Storage unit
19 Display unit
20 User interface
P Flow path
P11 Sample liquid flow path
P12 Sheath liquid flow path
P13 Main flow path
P14 Optical detection region
D Droplet
BOP Break-off position
O Orifice
R Conductive portion
R1 Connection portion
R2 Support portion
U Orifice unit for particle sorting device

1. A particle sorting device comprising:
an irradiation unit that irradiates a part of a flow path through which a fluid containing particles flows with laser light;
a detection unit that detects light generated by irradiation of the laser light;
an orifice that is disposed at an end of the flow path and discharges the fluid;
a conductive portion disposed in a vicinity of a position where the fluid is formed into a droplet; and
a charging unit that applies a charge to the conductive portion on a basis of light data detected by the detection unit.

2. The particle sorting device according to claim 1, wherein a part or all of the orifice has conductivity.

3. The particle sorting device according to claim 2, wherein the conductive portion supports the orifice.

4. The particle sorting device according to claim 3, wherein the orifice is replaceable.

5. The particle sorting device according to claim 4, wherein the conductive portion is replaceable.

6. The particle sorting device according to claim 5, wherein the conductive portion includes a holding portion held by a user at a time of replacement.

7. The particle sorting device according to claim 2, wherein the conductive portion includes a connection portion connected to the charging unit.

8. The particle sorting device according to claim 1, wherein the conductive portion is disposed so as to abut on the orifice.

9. The particle sorting device according to claim 2, wherein the orifice is formed in a replaceable chip.

10. The particle sorting device according to claim 1, further comprising
a ground electrode disposed in a vicinity of a position where the fluid is formed into a droplet, wherein
the charging unit applies a charge to the ground electrode.

11. The particle sorting device according to claim 1, wherein the charging unit corrects a charge amount of a droplet.

12. The particle sorting device according to claim 1, wherein the conductive portion is disposed downstream of a region irradiated with the laser light in a flow direction of the fluid.

13. The particle sorting device according to claim 1, wherein the conductive portion is formed of one or more conductive materials selected from a group including a metal, a conductive resin, and a non-conductor having a surface to which conductivity is imparted.

14. The particle sorting device according to claim 1, wherein the particle includes a cell.

15. An orifice unit for a particle sorting device, comprising:
an orifice that is partially or entirely conductive; and
a conductive portion that supports the orifice.

16. The orifice unit for the particle sorting device according to claim 15, further comprising a holding portion held by a user at a time of replacement.

17. The orifice unit for the particle sorting device according to claim 15, wherein the conductive portion includes a connection portion connected to a charging unit that applies a charge to the conductive portion.

18. The orifice unit for the particle sorting device according to claim 15,
wherein the orifice unit for the particle sorting device is attached in a screwing manner or a lateral insertion manner to an end of a flow path through which a fluid containing particles flows.

19. The orifice unit for the particle sorting device according to claim 15, further comprising a positioning mechanism for attachment to the end of the flow path.

20. A particle sorting method comprising:
an irradiation step of irradiating a part of a flow path through which a fluid containing particles flows with laser light;
a detection step of detecting light generated by irradiation of the laser light; and
a charging step of applying a charge to a conductive portion disposed in a vicinity of a position where the fluid is formed into a droplet on a basis of light data detected by the detection unit.
